(19) United States
(12) Patent Application Publication
(10) Pub. No.: US 2025/0285010 A1
(43) Pub. Date: Sep. 11, 2025

(54) MACHINE LEARNING BASED APPROACH FOR TARGETED ITEM RECOMMENDATIONS BASED ON LATENT RELATIONSHIPS AMONG USER FEATURES AND ITEMS OF DIFFERENT TYPES

(71) Applicant: INTUIT INC., Mountain View, CA (US)

(72) Inventors: Steven James BROWN, Champlin, MN (US); Lan JIN, Newark, CA (US); Prateek ANAND, Valley Center, CA (US); Shankar SANKARARAMAN, Burlingame, CA (US); Shivani GOWRISHANKAR, Santa Clara, CA (US); Pragya TRIPATHI, Oakland, CA (US); Jingyuan ZHANG, San Jose, CA (US); Jaspreet SINGH, Union City, CA (US); Zhewen FAN, San Diego, CA (US); Isaac Robert STORCH, Thousand Oaks, CA (US)

(21) Appl. No.: 18/671,148

(22) Filed: May 22, 2024

Related U.S. Application Data
(60) Provisional application No. 63/588,092, filed on Oct. 5, 2023.

(51) Int. Cl. G06N 20/00; G06Q 40/10

(52) U.S. Cl. CPC G06N 20/00; G06Q 40/10

(57) ABSTRACT

A method for automatically recommending items in a software application. Embodiments include retrieving attributes of a user of the software application and retrieving a machine learning model that has been trained through a supervised learning process based on labeled training data indicating whether users represented by user features historically selected, within the software application, first items of a first item type and second items of a second item type. In certain embodiments, the machine learning model is configured, as a result of the supervised learning process, to recognize latent relationships between the first items of the first item type and the second items of the second item type based on distances between embeddings. Embodiments include providing inputs to the machine learning model based on the attributes of the user and receiving, in response, indications of one or more recommended items of the first item type or the second item type.

### RELATED APPLICATIONS

This application claims the benefit of U.S. Provisional Application No. 63/588,092, entitled “MACHINE LEARNING BASED APPROACH FOR TARGETED ITEM RECOMMENDATIONS BASED ON LATENT RELATIONSHIPS AMONG USER FEATURES AND ITEMS OF DIFFERENT TYPES,” by the same inventors, filed 5 Oct. 2023, the contents of which are incorporated herein in their entirety.

### INTRODUCTION

Aspects of the present disclosure relate to particular machine learning techniques for targeted recommendations of items for selection within a software application. In particular, embodiments involve training a machine learning model to recognize latent relationships among users and different types of items such that training data related to one item type can be used by the machine learning model to determine when to recommend items of a different item type.

### BACKGROUND

Every year millions of people around the world utilize software applications to assist with countless aspects of life. Many software applications may provide targeted recommendations of items for selection by users, such as based on user attributes. For example, tax preparation software may assist users in preparation of tax returns by recommending tax deductions and/or tax credits based on limited information known about the users.

Existing techniques for automatically determining targeted item recommendations may be based on rules, such as recommending a particular item to all users that have one or more particular attributes, or more complex techniques such as the use of machine learning models. However, such existing techniques tend to be inflexible and may produce results of limited accuracy. For example, techniques based on fixed rules are not easily adapted as the list of possible items that can be recommended and/or the conditions under which such items may be selected changes, grows, and/or shrinks over time. Existing machine learning techniques generally require large amounts of training data based on ground truth data about past user selections of each particular item that is available for recommendation, and involve training models for specific item types. However, such existing machine learning techniques are limited in accuracy for a particular item based on the amount of training data related to historical selections of that particular item, and do not adapt well as the list of possible items that can be recommended and/or the conditions under which such items may be selected changes, grows, and/or shrinks over time. This problem is particularly pronounced in contexts such as tax preparation where regulations and/or procedures change on a regular basis (e.g., every year), resulting in an ever-shifting landscape of items and conditions under which such items can or should be selected.

What is needed are improved techniques for targeted recommendations of items for selection within a software application, particularly when items and the conditions under which items are to be selected change frequently.

### BRIEF SUMMARY

Aspects and advantages of embodiments of the present disclosure will be set forth in part in the following description, or may be learned from the description, or may be learned through practice of the embodiments.

A method for automatically recommending items in a software application through machine learning includes: retrieving a plurality of attributes of a user of the software application; retrieving a machine learning model that has been trained through a supervised learning process based on labeled training data indicating whether a plurality of users represented by a plurality of user features historically selected, within the software application, first items of a first item type and second items of a second item type, wherein the machine learning model is configured, as a result of the supervised learning process, to recognize latent relationships between the first items of the first item type and the second items of the second item type based on distances between embeddings; providing inputs to the machine learning model based on the plurality of attributes of the user; receiving, from the machine learning model, in response to the inputs, indications of one or more recommended items of the first item type or the second item type; and displaying, via a user interface, an item selection recommendation based on the indications of the one or more recommended items of the first item type or the second item type.

A method for machine learning model training includes: retrieving user attributes of a plurality of users of a software application; retrieving item attributes of a first plurality of items of a first item type and a second plurality of items of a second type; generating embeddings of the first plurality of items and the second plurality of items based on the plurality of item attributes; retrieving item selection data indicating whether items of the first plurality of items and the second plurality of items were historically selected by the plurality of users; generating a labeled training data set for a machine learning model based on the user attributes, b, and the item selection data, wherein the training data set does not include identifiers of the first plurality of items and the second plurality of items; and training the machine learning model through a supervised learning process based on the labeled training data set to output indications of one or more recommended items of the first item type or the second item type in response to input user features, wherein the machine learning model is configured, as a result of the supervised learning process, to recognize latent relationships between the first plurality of items of the first item type and the second plurality of items of the second item type based on distances between the embeddings.

Further embodiments include a non-transitory computer-readable storage medium storing instructions that, when executed by a computer system, cause the computer system to perform the method set forth above. Further embodiments include a system comprising at least one memory and at least one processor configured to perform the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment including components related to automatically recommending items in a software application through machine learning according to embodiments of the present disclosure.

FIG. 2A depicts a first data set from which training data is generated for training a machine learning model for automatically recommending items in a software application according to embodiments of the present disclosure.

FIG. 2B depicts a second data set from which training data is generated for training a machine learning model for automatically recommending items in a software application according to embodiments of the present disclosure.

FIG. 2C depicts a third data set from which training data is generated for training a machine learning model for automatically recommending items in a software application according to embodiments of the present disclosure.

FIG. 3 depicts labeled training data that is used to train a machine learning model for automatically recommending items in a software application according to embodiments of the present disclosure.

FIG. 4 depicts an example user interface screen related to automatically recommending items in a software application through machine learning according to embodiments of the present disclosure.

FIG. 5 depicts example operations related to automatically recommending items in a software application through machine learning according to embodiments of the present disclosure.

FIG. 6 depicts example operations related to training a machine learning model for automatically recommending items in a software application according to embodiments of the present disclosure.

FIGS. 7A and 7B depict example processing systems related to automatically recommending items in a software application through machine learning according to embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to automatically recommending items in a software application through a particular machine learning process by which latent relationships among users and items of different item types are automatically recognized.

Conventional techniques for automatically recommending items for selection within a software application generally involve fixed rules or particular machine learning techniques that have a variety of drawbacks in highly dynamic environments. For example, using fixed rules indicating that certain items should be recommended under certain conditions may provide some useful results when the items to be recommended remain relatively static, when the conditions under which items can or should be selected do not change much over time, and when the items are not particularly complex. However, such techniques do not adapt well to items that change frequently and/or when the conditions under which items can or should be selected change frequently.

Existing machine learning techniques for automatically recommending items for selection within a software application generally involve training a model for recommending a particular item based on labeled training data that is generated from ground truth data indicating historical user selections of that particular item. For example, a training data instance in such existing techniques may include features of a user associated with a label indicating whether or not that user selected that particular item (e.g., with the item being identified explicitly in the training data that is used to train the model). While these techniques can provide some useful results under relatively static conditions, they require large amounts of labeled training data that is specific to each item that could potentially be recommended, and do not adapt well to items that change frequently and/or when the conditions under which items can or should be selected change frequently. For example, training a machine learning model using such conventional techniques to output tax deductions for recommendation to a user (e.g., based on training that identifies specific tax deductions in the labels) and training a separate machine learning model in such a manner to output tax credits for recommendation to a user (e.g., based on training that identifies specific tax credits in the labels) may provide some utility, but requires large amounts of labeled training data for both tax deductions and tax credits, and does not allow for identification of potential recommendations based on more nuanced relationships, such as those between tax credits and tax deductions.

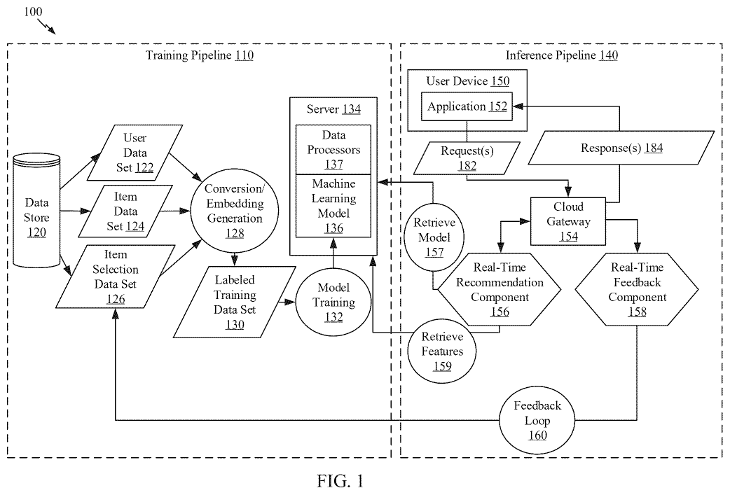

Embodiments of the present disclosure overcome these problems with existing techniques through a particular machine learning technique by which a machine learning model is trained to recognize latent relationships among users and items of different types. For example, rather than training separate models for different item types, and rather than training one or more machine learning models based on labeled training data that identifies specific items (e.g., through item identifiers being included in the training data), techniques described herein involve training a single machine learning model for multiple different item types based on labeled training data that does not directly identify specific items, but instead includes embeddings generated based on features of particular items, user features, and labels indicating whether the users represented by the user features historically selected the items (of multiple item types) represented by the embeddings. As described in more detail below with respect to FIG. 1, embodiments of the present disclosure allow a machine learning model to be trained to recognize latent relationships among users and items of multiple different types, such that (for example) training data generated from ground truth data for an item of a first item type can be used by the machine learning model to determine whether to recommend items of a second item type. Distances between embeddings representing items, for example, may allow the machine learning model to determine similarities between items within a particular item type as well as between items of different item types.

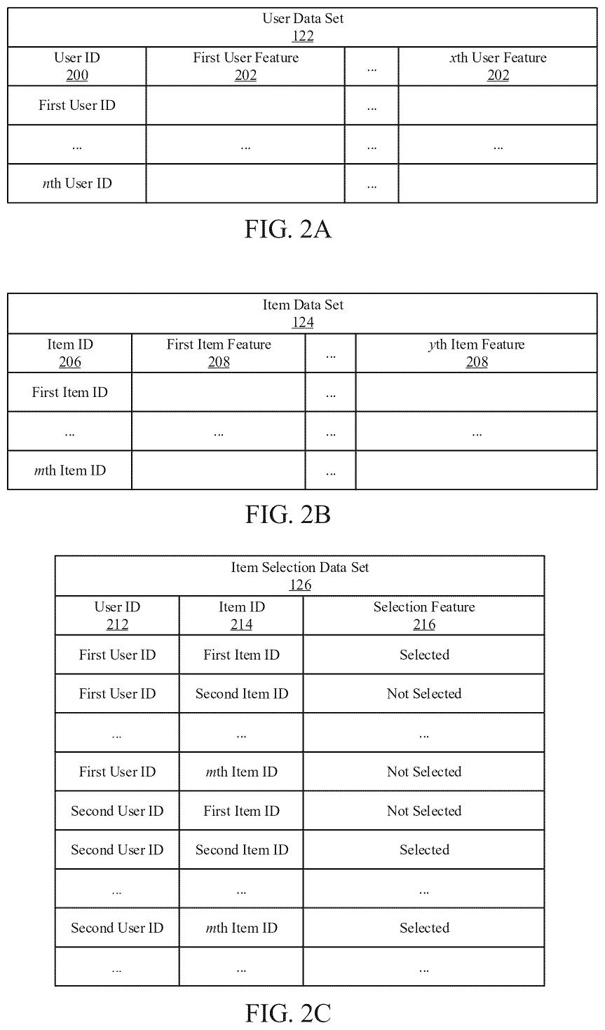

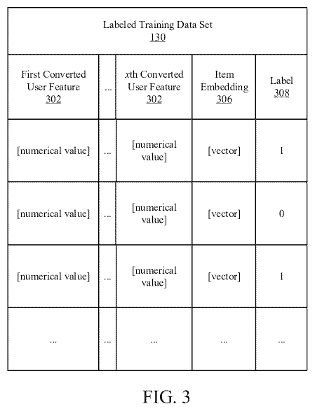

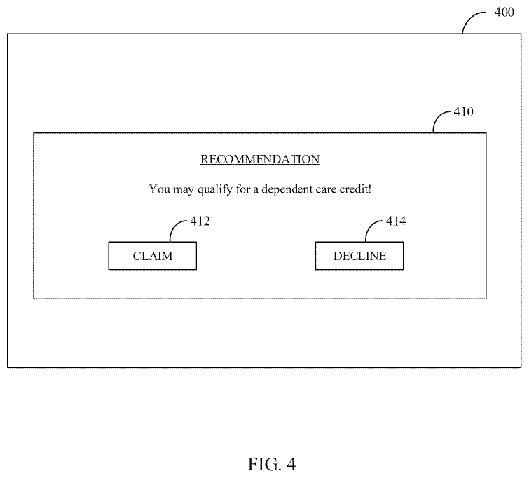

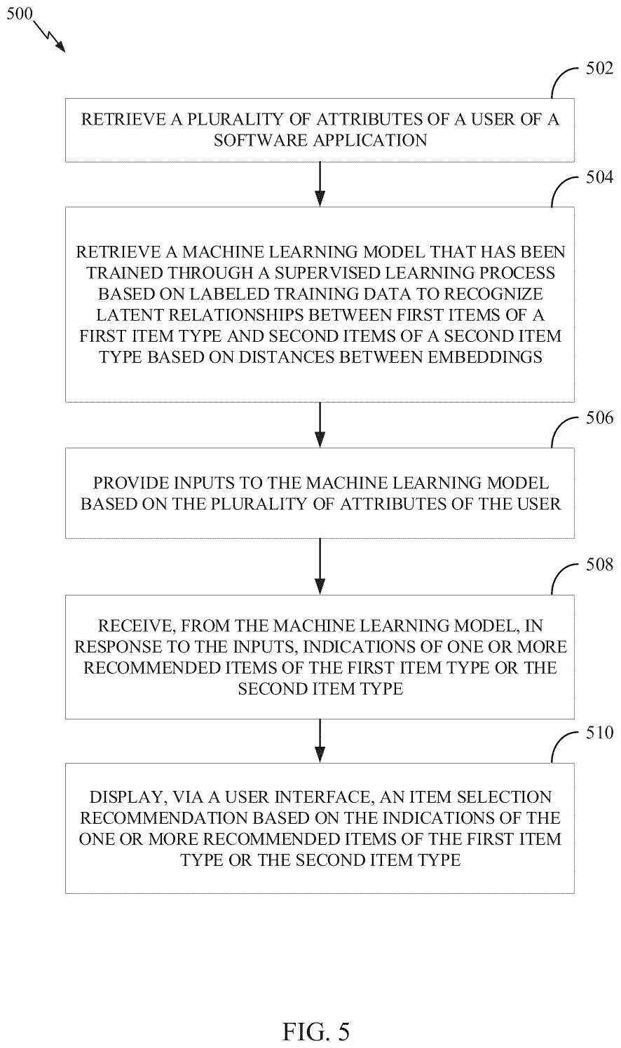

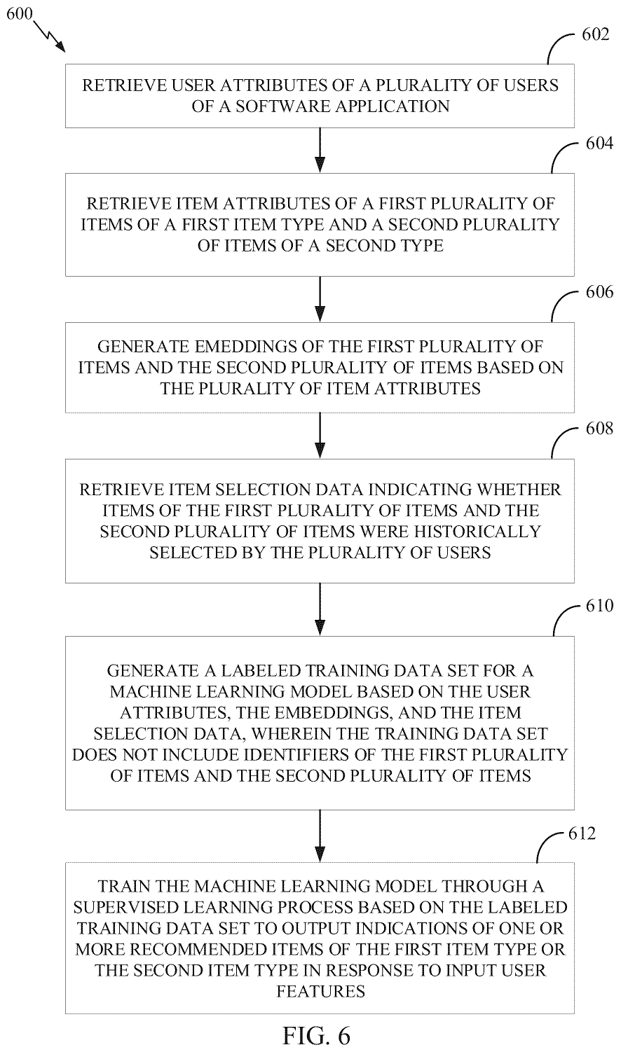

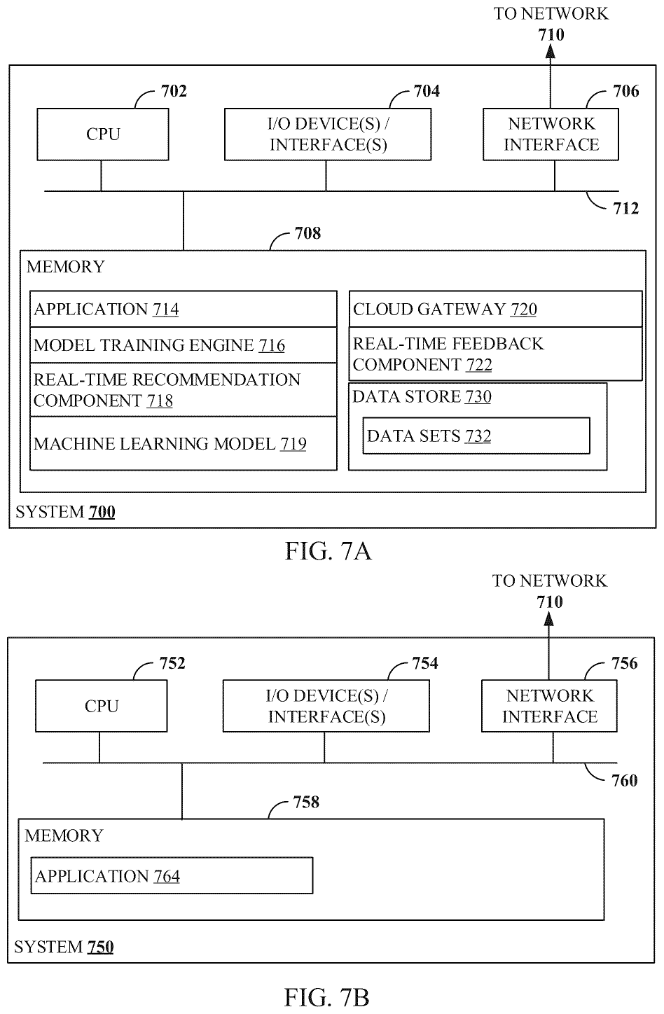

Generation of training data for use in training such a machine learning model is described in more detail below with respect to FIGS. 2A, 2B, and 2C, and FIG. 3. An item recommendation generated based on such a machine learning model is described below with respect to FIG. 4. Example methods of using and training such a machine learning model arc described below with respect to FIGS. 5 and 6. Example computing systems with which embodiments of the present disclosure may be implemented are described below with respect to FIGS. 7A and 7B.

In some embodiments, a user may provide feedback on the recommendation(s) generated using techniques described herein. For instance, the user may select or choose not to select one or more recommended items. In some embodiments, updated training data may be generated based on the feedback from the user, and the machine learning model may be re-trained based on the updated training data. In this manner, the machine learning model may be iteratively re-trained in an ongoing interactive feedback loop by which user interactions with the software application are used to iteratively improve the accuracy of results obtained from the machine learning model. In some embodiments, the updated training data for the machine learning model may be generated in real-time as the feedback (e.g., selection and/or non-selection for each of the recommended items) is received from the user, and the machine learning model may be re-trained in real-time. In alternative embodiments, the user feedback may be provided to a database and the updated training data may be generated in batch (that is, all at once) at a later time, such as for re-training the machine learning model at regular intervals.

One example embodiment of the present disclosure relates to financial management software, and particularly to a software application that assists users with preparation of tax returns. For example, the “items” that can be recommended for selection may refer to tax deductions and/or tax credits that can be recommended for a user to claim on a tax return. For example, a first item type may refer to tax deductions and a second item type may refer to tax credits, while particular items within these types may refer to particular tax deductions (e.g., student loan interest deduction) and particular tax credits (e.g., dependent care credit). Thus, rather than training separate models for tax deductions and tax credits, embodiments of the present disclosure utilize a single model for both tax deductions and tax credits, and allow latent relationships between tax deductions and tax credits (in addition to latent relationships between tax deductions and other tax deductions, and between tax credits and other tax credits) to inform the model's selection of tax deductions and tax credits for recommendation to a user. It is noted that this is included as an example, and other type of items in other types of software applications may also be recommended for selection using techniques described herein.

Techniques described herein provide multiple technical improvements over existing techniques for automated recommendations of items for selection with a software application. For example, as compared to existing techniques that are based on fixed rules and are therefore of limited value in dynamic contexts, embodiments of the present disclosure are able to provide dynamic recommendations of items for selection in a software application even when the items and/or the conditions under which the items can or should be selected change frequently, such as through the use of a machine learning model that is trained to dynamically select items for recommendation based on learned latent relationships.

Furthermore, as compared to existing machine learning techniques that involve training separate models for separate item types and/or training one or more models based on training data that identifies specific items, embodiments of the present disclosure provide greater adaptability and accuracy. For example, when the items and/or the conditions under which the items can or should be selected change frequently, techniques described herein provide such flexibility by training a machine learning model to recognize latent relationships among users and items of multiple item types, therefore allowing the model to apply insights gained from training data generated before such a change (e.g., a change to an item, to the list of possible items, or to a condition under which an item can or should be selected) successfully to recommendations generated after the change due to the use of embeddings and/or other latent representations of features rather than fixed identifiers. For instance, rather than training data instances that include user features associated with labels indicating whether the users represented by the user features historically selected particular items that are explicitly identified (e.g., which requires large amounts of ground truth data for each particular item and does not provide much flexibility), embodiments of the present disclosure involve training data instances that include user features and item embeddings associated with labels indicating whether the users represented by the user features historically selected the items represented by the item embeddings (e.g., the item embeddings are input features, and identifiers of the items are not included in the input features or the labels of the training data), thereby allowing latent similarities among the items, even across different item types, to be recognized by the machine learning model. Thus, techniques described herein allow training data generated from ground truth for one item or item type to be applied to recommendations for other items, even of different item types, and even after changes to items, additions of new items, and/or changes to conditions under which items can or should be selected, therefore requiring less training data and producing improved results even in complex and dynamic environments. For example, a machine learning model trained as described herein may allow for recommendations of items that were not included in the training data used to train the model.

Furthermore, by utilizing a single machine learning model to generate item recommendations across multiple items and multiple item types instead of having multiple machine learning models, with each model trained to determine whether to generate recommendations for a single item or item type, embodiments of the present disclosure avoid the computing resource utilization that would otherwise be associated with training and using multiple machine learning models, and thereby improve the functioning of the computing systems involved, while also allowing for cross-learning across different items and item types (e.g., based on latent relationships, as described herein). Additionally, by improving the accuracy of recommendations output by the machine learning model, techniques described herein avoid the computing resource utilization that would otherwise be associated with generating and providing inaccurate recommendations that would require additional actions from the user to identify correct items and additional processing to handle such actions.

In the context of tax preparation applications, techniques described herein may provide certain additional technical benefits. When individuals file tax returns, they may be eligible for tax deductions and credits. Tax deductions can reduce the amount of taxable income and tax credits can reduce the amount of taxes that filers owe to the federal and state governments, and/or can increase a tax refund. Tax deductions and tax credits are important components to determine the amount of taxes that filers owe to the federal government and state governments or the amount of refund that filers are eligible to receive. Each tax credit or deduction has unique eligibility requirements. A challenge faced by many tax filers is that they may not fully understand the requirements to claim credits or deductions and therefore, they could miss some credits or deductions that they are eligible for. Therefore, tax filers may seek help from tax filing assistants such as tax accountants or products, such as software applications that assist with tax preparation. Historically, such software applications have used either static rules to recommend credits and deductions or separate machine learning models trained specifically for tax credit recommendations or tax deduction recommendations. Due to the limited information that is available about a user at the point of recommendation, due to the highly dynamic nature of tax laws and regulations, and due to the difficulties and resources associated with generating large amounts of training data for each type of tax credit or tax deduction, these historical technical solutions are not optimized for automatically identifying tax credits and deductions that filers may qualify for but are not aware of. Thus, the technical improvements described above that are accomplished by techniques described herein (e.g., allowing for dynamic automatic item recommendations based on learning latent relationships among users and items of different types, such as latent relationships between tax credits and tax deductions based on embeddings) are particularly advantageous in the context of software applications that assist with tax preparation. For example, by training a single machine learning model for recommending tax deductions and tax credits, by using embeddings of the tax deductions and tax credits as input features in the labeled training data rather than including static identifiers of the tax deductions and tax credits in labels associated with the training data, and by training a machine learning model with such training data to recognize latent relationships between different items, even of different types (e.g., tax credits and tax deductions), embodiments of the present disclosure allow for more insightful automated recommendations of tax credits and tax deductions with less training data, less computing resource utilization (e.g., by using a single model trained as described herein), and greater adaptability.

Furthermore, certain embodiments involve the machine learning model outputting a confidence score in association with each recommendation indicating a level of confidence that the recommendation is accurate. By utilizing a single machine learning model for recommending multiple item types (e.g., tax deductions and tax credits), techniques described herein are configured such that the confidence scores output by the model for the multiple item types (tax deductions and tax credits) are in a common scale. Thus, according to embodiments of the present disclosure, confidence values in a common scale across multiple item types allow recommendations across the different item types to be grouped based on confidence level (e.g., low, medium, or high confidence). For example, a high confidence group may include both tax deduction recommendations and tax credit recommendations with confidence values in a first confidence range (e.g., above a first threshold), a medium confidence group may include both tax deduction recommendations and tax credit recommendations with confidence values in a second confidence range (e.g., below the first threshold but above a second threshold), and a low confidence group may include both tax deduction recommendations and tax credit recommendations with confidence values in a third confidence range (e.g., below the second threshold). These common groupings across item types allow items to be sorted, selected for display via a user interface, displayed in a particular manner via the user interface (e.g., with an indication of belonging to a particular confidence group and/or otherwise having a certain confidence level), and/or otherwise organized and managed in a common scale.

Machine Learning Based Techniques for Dynamic Targeted Item Recommendations in a Software Application

FIG. 1 illustrates a computing environment 100 for targeted recommendations of items for selection within a software application using machine learning techniques according to embodiments of the present disclosure. Computing environment 100 includes a user device 150, a server 134, a data store 120, and a cloud gateway 154, which may each be implemented via one or more physical computing devices, such as the computing systems discussed below with respect to FIGS. 7A and 7B. It should be appreciated that the user device 150, the server 134, the data store 120, and the cloud gateway 154, as well as other components described herein, may be communicatively coupled with one another via one or more networks (not shown). The network(s) may include, without limitation, a wide area network (WAN), a local area network (LAN), and/or a cellular network, and more generally may include any wired or wireless connection over which data may be transmitted.

A training pipeline 110 includes aspects related to generating training data and then using that training data to train a machine learning model 136 according to techniques described herein. For example, the processes described with respect to training pipeline 110 may be performed by a model training component running on one or more physical computing devices (e.g., the same as or separate from server 134). Training pipeline 110 may represent operations that are performed initially in order to generate machine learning model 136 and/or that may be performed iteratively over time, such as in real-time and/or at regular intervals, to re-train machine learning model 136.

In order to generate training data, multiple data sets are retrieved from a data store 120. Data store 120 generally represents a data storage entity such as a database or repository that stores data related to a software application, such as application 152, such as including data related to use of such an application by a plurality of users (e.g., that interact with the application via a plurality of user devices similar to user device 150).

User data set 122 generally represents data about a plurality of users of the application, such as including user attributes that may be used as features to represent the users as part of a machine learning process. An example of user data set 122 is described in more detail below with respect to FIG. 2A. For example, user data set 122 may include a unique identifier of each user associated with features for that user, such as known attributes of the user (e.g., the user's occupation, length of use of the application, application membership type, etc.), activities performed by the user within the application (e.g., clickstream data, documents associated with the user, forms previously completed by the user, etc.), and/or the like.

Item data set 124 generally represents data about items that are available for selection with the application. An example of item data set 124 is described in more detail below with respect to FIG. 2B. For example, item data set 124 may include a unique identifier of each item associated with features for that item, such as a name and/or description of the item, a category of the item, and/or the like. It is noted that item data set 124 may include data about items of multiple different item types, and the item identifiers may be unique across the multiple item types.

Item selection data set 126 generally represents data about historical selections of items by users within the application. An example of item selection data set 126 is described in more detail below with respect to FIG. 2C. For example, item selection data set 126 may include indications of which items (e.g., identified by the unique item identifiers) were historically selected by particular users (e.g., identified by the unique user identifiers).

In some embodiments, a unified data set (not shown) is generated by merging the user attributes from user data set 122 and the item attributes from item data set 124 based on the item selection data indicated in item selection data set 126, such as using the item identifiers of the items and the user identifiers of the plurality of users. User identifiers may be used as primary keys to join user data set 122 with other data sets (e.g., item data set 124 and/or item selection data set 126) for creation of the unified data set. In a particular example, user data set 122 is joined with item selection data set 126 on user identifier. Then, the result of that join operation is joined with item data set 124 on item identifier so that the features of the items are added to create the unified data set.

At conversion/embedding generation 128, one or more operations are performed in order to prepare a labeled training data set 130 based on user data set 122, item data set 124, and item selection data set 126 (e.g., based on the unified data set). For example, conversion/embedding generation 128 may involve converting features indicated in these data sets (or in the unified data set) into a suitable form for use as training data for a model. Textual features may be converted into numerical form, such as using embeddings, encodings, and/or other techniques. Sensitive information in the data sets may be stripped out as appropriate (e.g., by using machine learning, rules, and/or regular expressions to identify such sensitive information and removing identified sensitive information and/or replacing such sensitive information with dummy information). Visual features and/or other non-textual and/or non-numerical features may be converted into numerical form, such as using numerical codes to represent selections or non-selections of check boxes.

In particular embodiments, an embedding is generated for each item represented in item data set 124. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating embeddings are possible.

For example, one or more features of each item (e.g., name, category, and/or the like) are provided as inputs to an embedding model, and the embedding model outputs an embedding for each item. Embeddings of items may be included in labeled training data set 130 rather than including identifiers of the items in the labeled training data, such as to allow latent relationships between different items, including across different item types, to be recognized by the model as a result of the training process, so that such latent relationships may inform the model's selection of items to recommend to a given user. Embeddings of other features (e.g., textual features) represented in user data set 122 and/or item data set 124 may also be generated in certain embodiments. In some embodiments, one or more dimensionality reduction techniques may be applied to embeddings, such as principal component analysis (PCA) or other such techniques in order to reduce the size of such embeddings for improved computing resource utilization while maintaining the useful information contained in the embeddings.

The result of conversion/embedding generation 128 may be a converted unified data set that is then used to generate labeled training data set 130 (e.g., which may at least involve removing the user identifiers and item identifiers from the converted unified data set).

In one specific example, in the context of a tax preparation software application, wages and federal withholdings on w2 forms are aggregated as the sum of such values if the tax-filer has several w2 forms. For those w2 boxes (e.g., box 12 and box 14) with codes, the data pipeline first transforms each box code into a feature column and the feature values are aggregated as the sum of amounts. Next, other categorical features (e.g., filing status can be single, married filing jointly, married filing separately, etc.) are imputed with mode values and encoded to numerical values. Further, the name and category of each item (e.g., tax credit or tax deduction) are transformed into embeddings, such as by using natural language processing techniques (e.g., a BERT model). Further feature processing techniques, for instance, principal component analysis, can be applied if necessary. These newly created columns are named as item feature 1, item feature 2, etc. Next, the item identifier column in the unified dataset is replaced with the associated item features (e.g., which include an embedding). Subsequently, the user identifier column will be dropped before feeding the processed data into a machine learning model as training data.

An example of labeled training data set 130 is described below with respect to FIG. 3. For example, labeled training data set 130 may include a plurality of labeled training data instances, where each labeled training data instance includes features of a particular user and features of a particular item (e.g., an embedding of the particular item) associated with a label indicating whether the particular user historically selected the particular item. In some embodiments, the label is in the form of a binary indication (e.g., 1 for selected and 0 for not selected). In certain embodiments, the training data instances do not include the user identifiers or the item identifiers. By including an embedding of a given item as an input feature along with features of a user, rather than including an identifier of the given item (e.g., in a label), in training data set 130, techniques described herein allow machine learning model 136 to be trained to recognize latent relationships among users and different items, even of different item types, such that when the trained model is provided with a set of input features representing a user and an item the model may determine whether to recommend the item for selection by the user not only (or necessarily even at all) based on training data specific to that item, but also based on training data from historical selections of different items that can be compared to the item via the embeddings.

At model training 132, labeled training data set 130 is used to train machine learning model 136 through a supervised learning process. In some embodiments, model training 132 is a supervised learning process that involves providing training inputs (e.g., features of a user and features, such as an embedding, of an item) as inputs to machine learning model 136. Machine learning model 136 processes the training inputs and outputs predictions (e.g., an indication of whether the item should be recommended to the user and/or a confidence score indicating a level of confidence that the item should or should not be recommended to the user) based on the training inputs. The predictions are compared to the known labels associated with the training inputs (e.g., a binary label indicating whether the user historically selected the item) to determine the accuracy of the machine learning model, and parameters of machine learning model 136 are iteratively adjusted until one or more conditions are met. For instance, the one or more conditions may relate to an objective function (e.g., a cost function or loss function) for optimizing one or more variables (e.g., model accuracy, model precision, model recall, and/or the like). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art.

Machine learning model 136 may, for example, be a binary classification model. In one example, machine learning model 136 is an XGBoost model. A tree model (e.g., a decision tree) makes a classification by dividing the inputs into smaller classifications (at nodes), which result in an ultimate classification at a leaf. Boosting, or gradient boosting, is a method for optimizing tree models. Boosting involves building a model of trees in a stage-wise fashion, optimizing an arbitrary differentiable loss function. In particular, boosting combines weak “learners” into a single strong learner in an iterative fashion. A weak learner generally refers to a classifier that chooses a threshold for one feature and splits the data on that threshold, is trained on that specific feature, and generally is only slightly correlated with the true classification (e.g., being at least more accurate than random guessing). A strong learner is a classifier that is arbitrarily well-correlated with the true classification, which may be achieved through a process that combines multiple weak learners in a manner that optimizes an arbitrary differentiable loss function. The process for generating a strong learner may involve a majority vote of weak learners. An XGBoost model is an example of a gradient boosted model.

In another example, machine learning model 136 is a random forest model. A random forest extends the concept of a decision tree model, except the nodes included in any given decision tree within the forest are selected with some randomness. Thus, random forests may reduce bias and group outcomes based upon the most likely positive responses.

It is noted that these are included as example model types, and machine learning model 136 may be any suitable type of machine learning model (e.g., that is trained through supervised learning methods), such as a neural network, linear regression model, or the like.

As a result of model training 132, machine learning model 136 is configured to recognize latent relationships among users and items, even items of different types, and is able to apply knowledge gained from training data for one type of item to a determination of whether to recommend items of another type to a user (e.g., based on distances between the embeddings of the items), according to the connections and/or other parameters of the model that were configured during model training 132.

Additionally, data processors 137 used to process features to prepare them for being input into the model (e.g., components used during conversion/embedding generation 128 and otherwise to generate labeled training data set 130) may be stored as one or more objects that can be used to convert features in real-time to numerical features so that they can be provided as inputs to the trained machine learning model for use in generating item selection recommendations. Such data processors 137 may include, for example, one or more embedding models, one or more encoding components, one or more dimensionality reduction components, and/or one or more other components that are used to process input features to prepare them for being provided as inputs to the model (e.g., converting such features into numerical values).

Machine learning model 136 (e.g., once trained) may be deployed to a server 134, where it can be used to provide recommendations of items for selection by users within the application. Data processors 137 may also be deployed to server 134. In certain embodiments, an object is created that stores the trained machine learning model 136 artifact along with all data processors 137 used to prepare input features for being provided as inputs to the model. For example, server 134 may be a cloud server or other type of server that can be accessed in order to retrieve machine learning model 136 (e.g., retrieve the object that includes the model artifact and data processors 137) for use in determining item selection recommendations. In some embodiments, a cloud gateway 154 associated with server 134 allows user devices (e.g., user device 150) to request and receive item selection recommendations, such as via calls to an application programming interface (API), and cloud gateway 154 orchestrates access to server 134 in order to retrieve and/or otherwise use machine learning model 136 (e.g., and associated data processors 137) for the purpose of determining such recommendations. For example, a microservice (e.g., cloud gateway 154) may be hosted on server 134, and may expose a representational state transfer (REST) API including methods such as a real-time recommendation method (e.g., represented by real-time recommendation component 156) and a real-time feedback method (e.g., represented by real-time feedback component 158). It is noted that the particular architectures described herein, such as a client-server architecture, the use of a cloud server, the use of a cloud gateway, the use of an API, and/or the like are included as examples, and techniques described herein may be employed with different architectures (e.g., as a standalone system on a single device, and/or with more or fewer local and/or remote devices and/or components).

An inference pipeline 140 includes aspects related to using a machine learning model (e.g., trained as described above with respect to training pipeline 110) to automatically determine items to recommend to a user for selection within a software application. For example, the processes described with respect to inference pipeline 140 may be performed by application 152 and/or one or more additional local or remote components running on one or more physical computing devices (e.g., the same as or separate from user device 150).

User device 150 generally represents a device by which a user interacts with application 152. For example, application 152 may be a standalone application or client-side component of a client-server paradigm that also includes a server-side component with which application 152 interacts (e.g., via API calls). Such a server-side component may run on server 134 or a different server.

Application 152 generally represents a software application that allows a user to select particular items in order to complete one or more workflows. In one particular example, application 152 is a tax preparation application that allows users to select tax deductions (e.g., which is an example of items of a first item type) and tax credits (e.g., which is an example of items of a second item type) to claim on tax returns. More than two item types may also be included.

Application 152 (or a remote component, such as a server-side application) uses machine learning model 136 to automatically determine items to recommend to the user of user device 150 for selection. For example, a user of user device 150 may land on a page within application 152, and application 152 (e.g., which could be a web browser that interacts with a remote application) may request model-based recommendations of items for selection to provide to the user, such as providing information identifying the user and any relevant attributes known so far by application 152.

In one example implementation, application 152 sends one or more requests 182 to cloud gateway 154 in order to invoke functionality exposed by cloud gateway 154, such as requesting item recommendation(s) and/or requesting components for use in determining item recommendation(s), and (in some embodiments) including information such as the identity of the user and/or known attributes of the user within such request(s) 182. For example a real-rime recommendation component 156 (e.g., which may be a method that can be invoked via an API exposed by cloud gateway 154) may, at step 157, retrieve machine learning model 136 from server 134. In one example, an object that includes the trained machine learning model 136 artifact and one or more data processors 137 for use in preparing input data for the model is retrieved. For example, at step 159 (or as part of a single step 157), real-rime recommendation component 156 may retrieve data processors 137 for use in preparing features for use in providing inputs to machine learning model 136, as needed. Furthermore, if additional features are needed, those features may be retrieved from one or more other components (e.g., data store 120), such as based on the identity of the user and/or other information provided by application 152. For example, the features used to provide inputs to the model may include user features of the user of user device 150 for whom recommendations are to be generated, and may also include features (e.g., embeddings) of items that could potentially be recommended to the user for selection.

Once machine learning model 136 (and, in some embodiments, one or more data processors 137) and any required features are retrieved, the machine learning model 136 (and, in some embodiments, data processors 137) and the features may be returned to application 152 (e.g., via one or more responses 184 to one or more requests 182), or machine learning model 136 may be run on a device other than user device 150, such as a server (e.g., the model artifact may be used to run the model on server 134 or another server). In some embodiments, machine learning model 136 runs on server 134, and the features to be provided as inputs to machine learning model 136 are sent to server 134 for use in determining recommendations for the user (e.g., recommendations determined from executing the model may then be returned to application 152, such as via one or more responses 184). If the model and features are returned to application 152, then machine learning model 136 may be run on user device 150. One or more data processors 137 may also be executed on the same device or a different device than the model.

The features retrieved (and/or features that do not need to be retrieved, such as features that are already known at user device 150 or the other device on which the model is run) are used to provide inputs to machine learning model 136 in order to determine one or more item selection recommendations to provide to the user. For example, the features may include user attributes of the user (e.g., the same as or similar to the features included in user data set 122 during training). The features may also include features (e.g., embeddings) of the possible items that could be recommended. If not already performed, the retrieved features may be converted and/or otherwise adapted into training data, such as converting textual and other types of non-numerical features into numerical values. In some embodiments, embeddings of one or more retrieved features may be generated for inclusion in the inputs provided to machine learning model 136. In certain embodiments, one or more data processors 137 retrieved from server 134 are used for such preparation of input features for being provided to the model.

Machine learning model 136 processes the inputs and, in response, outputs indications of whether each of a plurality of items should be recommended to the user for selection. For example, in response to each combination of the user's features and a given item's embedding, machine learning model 136 may output an indication of whether the given item should be recommended to the user. In some embodiments, the model outputs a respective confidence score indicating an amount of confidence (e.g., a value between 0 and 1) that each respective item should be recommended to the user for selection. In some embodiments, the items are ordered by descending confidence scores and, optionally, divided into groups of items with high confidence, medium confidence, and low confidence based on confidence ranges. Because the machine learning model is trained across multiple item types (e.g., tax deductions and tax credits), the confidence scores will be in a common scale across the multiple item types, and items can be grouped in the common scale according to confidence. For example, a high confidence group may include both tax deduction recommendations and tax credit recommendations, and these recommendations may be provided together via a user interface and/or otherwise managed together.

One or more items indicated in the outputs from machine learning model 136 may be recommended to the user for selection, such as via a user interface associated with application 152 that is displayed on user device 150. For example, any items for which the model outputs a confidence score over a threshold (e.g., items in the high confidence group or at least in the medium confidence group) may be recommended to the user for selection, while items for which the model outputs a confidence score that is not above the threshold may not be recommended to the user. In certain embodiments items are recommended one at a time to the user (e.g., in order of confidence scores, from high to low), while in other embodiments all items meeting a condition for recommendation are recommended to the user together. An example of an item selection recommendation displayed via a user interface is described below with respect to FIG. 4. For example, if application 152 is a tax preparation application, one or more tax deductions and/or tax credits may be recommended to the user via the user interface (e.g., as part of a workflow that guides the user through preparation of a tax return). In such cases, machine learning model 136 may recognize relationships among particular tax deductions and particular tax credits as a result of model training 132 (e.g., based on the embeddings used during training and provided as inputs to the model), and may output recommendations of tax credits that are based on training data from historical selections of tax deductions, as well as recommendations of tax deductions that are based on training data from historical selections of tax credits. Furthermore, machine learning model 136 may recognize relationships between different users based on user features in order to apply insights gained from one user to another user.

The user may provide feedback with respect to one or more item selection recommendations that are presented based on output(s) from machine learning model 136, and the user feedback may be used to generate updated training data for re-training machine learning model 136. For example, application 152 may provide such feedback for use in re-training by interacting with cloud gateway 154 (e.g., through an API call), and real-time feedback component 158 (e.g., a method invoked via the API call) may provide the user feedback to the model training component in a feedback loop 160. In certain embodiments, feedback loop 160 allows an updated item selection data set 126 to be generated based on the user feedback, such as indicating that the user selected or did not select one or more recommended items. In some embodiments, if the user ignores a recommendation of an item for a given amount of time, that is treated as the user not selecting the recommended item. User feedback may be provided to the back-end for training either in real-time or in batch (e.g., at regular intervals and/or when a threshold amount of new user feedback is available).

The updated item selection data set 126 may be used to produce an updated labeled training data set 130 (e.g., in a manner similar to that described above) that reflects the user feedback, and the updated labeled training data set 130 may be used to re-train machine learning model 136 in a manner similar to that described above with respect to model training 132. Once re-trained, machine learning model 136 may then be used to determine subsequent item selection recommendations as described above with respect to inference pipeline 140, and may produce increasingly accurate outputs as a result of the ongoing re-training.

### Generation of Training Data for a Machine Learning Model

FIGS. 2A-2C illustrate, respectively, the user data set 122, the item data set 124, and the item selection data set 126 of FIG. 1 from which labeled training data set 130 of FIG. 1 is generated.

As shown in FIG. 2A, user data set 122 includes, for each of a plurality of users (e.g., including a total of n unique users), a user identifier 200 (e.g., a unique identifier of each user, such as a taxpayer identification number) of a software application (such as application 152 discussed above with reference to FIG. 1). User data set 122 also includes, for each of the plurality of users, a plurality of different user features 202 (e.g., including a total of x user features for each user). The plurality of different user features 202 may include user attributes, such as based on past interactions of users with the application. In one example, the application is a tax preparation application, and the plurality of different user features 202 includes information from one or more current and/or prior tax filings (e.g., tax returns). For example, the information may include, without limitation, total income, total number of dependents, total number of deductible expenses, a code included in a box of a tax form (e.g., a W2 box 12 code), an amount of earned income tax credit, an amount of moving expenses, and/or the like. In one particular example, the plurality of different user features 202 includes such features from multiple different tax years (e.g., from a current year and an immediately prior year, from the two or three most recent tax years for which such information is available, and/or the like). In some embodiments, the user features are based on tax credits and deductions that users claimed in the past, tax form data from forms such as W2, 1099, and 1098 forms, other past year tax return data, and/or the like.

In some cases, user data set 122 is based on past interactions of users with the application, such as using the application to prepare and file tax returns and/or entering such information into the application as part of a process for preparing a tax return. In certain embodiments, such information is obtained from one or more other sources, such as through interaction with a separate database (e.g., associated with a government agency, employer, and/or the like).

As shown in FIG. 2B, item data set 124 includes, for each of a plurality of items (e.g., including a total of m unique items), an item identifier 206 (e.g., a unique identifier of each item). Item data set 124 also includes, for each of the plurality of items, a plurality of different item features 208 (e.g., including a total of y item features for each item). The plurality of different item features 208 may include item attributes, such as names and categories of the items. A category may include a plurality of different items. In one example, the application is a tax preparation application, and the plurality of different item features 208 includes a name of each tax deduction or tax credit and a category of each tax deduction or tax credit (e.g., categories assigned within the application, such as by experts, including categories such as “you and your family,” “your home,” “estimates and other taxes paid,” and/or the like). Other item features are possible.

As shown in FIG. 2C, item selection data set 126 includes, for each respective user of the n users in user data set 122, an association between the respective user's identifier 212 (e.g., which may be the same identifier as in user identifiers 202 above) and each of the m items' identifiers 214 (e.g., which may be the same identifiers as in item identifiers 206 above) with a selection feature 216 indicating whether the respective user historically selected or historically did not select each of the items. For example, item selection data set 126 may include a first row that includes the first user's identifier, the first item's identifier, and an indication of whether the first user historically selected the first item. A second row may include the first user's identifier, the second item's identifier, and an indication of whether the first user historically selected the second item. This may be repeated for each combination of user and item (e.g., for which item selection data is available).

FIG. 3 illustrates an example of labeled training data 130 of FIG. 1 according to some embodiments of the present disclosure. Labeled training data 130 may be based on user data set 122 of FIG. 2A, item data set 124 of FIG. 2B, and item selection data set 126 of FIG. 2C. For example, as described above, labeled training data 130 may be generated as a result of conversion/embedding generation 128 of FIG. 1.

As shown, labeled training data set 130 includes associations between converted user features 302 (e.g., converted into numerical form as needed), item embeddings 306 (e.g., generated based on one or more features of each item), and labels 308 indicating binary values (e.g., 1 or 0) representing whether the users represented by the converted user features historically selected the items represented by the item embeddings. In some embodiments, all x user features from user data set 122 of FIG. 2A are included (e.g., in converted form as appropriate) in labeled training data set 130, while in other embodiments some of the x user features from user data set 122 of FIG. 2A are excluded from labeled training data set 130 (e.g., based on such features not being useful, including sensitive information, and/or otherwise not being suitable for use in training data). Furthermore, while only one item embedding 306 is shown for each training data instance in labeled training data set 130, other item features may also be included.

Generally, each training data instance within labeled training data set 130 includes “genericized” features of a given user and a “genericized” embedding of a given item associated with a label indicating whether the given user historically selected the given item. These features and embeddings are genericized because they do not include identifiers of particular users or particular items, being instead representations of users and items that can be compared to comparable representations of other users and other items. While conventional techniques would involve training data that associates features of a user with a label indicating whether the user selected a particular item that is identified by an identifier, embodiments of the present disclosure provide more flexibility and allow cross-training between different items and different item types through the use of genericized features such as embeddings of items.

### Example User Interface Screen for Automated Item Recommendations

FIG. 4 depicts an example user interface screen 400 related to automatically recommending items in a software application through machine learning according to embodiments of the present disclosure. For example, user interface screen 400 may be associated with application 152 of FIG. 1, and may be displayed on user device 150 of FIG. 1.

A window 410 displayed within user interface screen 400 includes a recommendation of a particular item for selection by the user. In the depicted example, the recommendation indicates that the user “may qualify for a dependent care credit.” Window 410 includes user interface controls 412 and 414 that allow the user to accept or decline the recommendation. For example, user interface control 412 may be configured to, when selected, initiate a workflow for claiming the recommended tax credit (e.g., dependent care credit) and user interface control 414 may be configured to, when selected, close out of window 410 and otherwise proceed without claiming the recommended tax credit. In other embodiments, more than one item recommendation may be displayed together in a user interface, such as within user interface screen 400. For example, a list of item recommendations ordered by confidence score may be displayed.

It is noted that the example of recommending particular tax credits and tax deductions within a tax preparation software application is not limiting, and techniques described herein may be used to provide recommendations of other types of items for selection within other types of software applications.

User feedback provided with respect to the recommendation, such as via user interface control 412 or 414, may be used to generate updated training data for use in re-training the machine learning model in an interactive feedback loop by which the model is incrementally improved.

### Example Method for Automatically Recommending Items in a Software Application Through Machine Learning

FIG. 5 depicts example operations 500 related to automatically recommending items in a software application through machine learning according to embodiments of the present disclosure. For example, operations 500 may be performed by one or more components described above with respect to computing environment 100 of FIG. 1.

Operations 500 begin at step 502, with retrieving a plurality of attributes of a user of the software application. In some embodiments, the plurality of attributes of the user comprise one or more of: tax information for the user for a current year; and tax information for the user for a prior year.

Operations 500 continue at step 504, with retrieving a machine learning model that has been trained through a supervised learning process based on labeled training data indicating whether a plurality of users represented by a plurality of user features historically selected, within the software application, first items of a first item type and second items of a second item type, wherein the machine learning model is configured, as a result of the supervised learning process, to recognize latent relationships between the first items of the first item type and the second items of the second item type based on distances between embeddings. It is noted that items of more than two item types may also be included in the labeled training data. For example, the machine learning model may be trained based on labeled training data relating to two or more item types, and may output recommendations of items of two or more item types.

In certain embodiments, the labeled training data set does not include identifiers of the first items of the first item type and the second items of the second type, and wherein the labeled training data set includes a respective embedding of each item of the first items of the first item type and the second items of the second type. In some embodiments, the first item type is tax deductions, wherein the first items comprise a plurality of different tax deductions, wherein the second item type is tax credits, and wherein the second items comprise a plurality of different tax credits.

In some embodiments, the machine learning model comprises a gradient boosted tree model.

Operations 500 continue at step 506, with providing inputs to the machine learning model based on the plurality of attributes of the user.

In some embodiments, the machine learning model processes the inputs along with each embedding of a plurality of embeddings generated based on the first items of the first item type and the second items of the second item type. For example, the embeddings may be generated based on features of the plurality of different tax deductions and the plurality of different tax credits, and wherein the features comprise names and categories.

Operations 500 continue at step 508, with receiving, from the machine learning model, in response to the inputs, indications of one or more recommended items of the first item type or the second item type.

In certain embodiments, the indications output by the machine learning model in response to the inputs comprise confidence scores for each of the first items of the first item type and for each of the second items of the second item type.

Operations 500 continue at step 510, with displaying, via a user interface, an item selection recommendation based on the indications of the one or more recommended items of the first item type or the second item type.

Some embodiments further comprise receiving, in response to the item selection recommendation, user feedback comprising a selection of one or more items within the software application, wherein the machine learning model is re-trained based on the user feedback, and using the re-trained machine learning model to determine a subsequent item selection recommendation.

### Example Method for Training a Machine Learning Model for Automatically Recommending Items in a Software Application

FIG. 6 depicts example operations 600 related to machine learning model training according to embodiments of the present disclosure. For example, operations 600 may be performed by one or more components described above with respect to computing environment 100 of FIG. 1.

Operations 600 begin at step 602, with retrieving user attributes of a plurality of users of a software application.

Operations 600 continue at step 604, with retrieving item attributes of a first plurality of items of a first item type and a second plurality of items of a second type.

Operations 600 continue at step 606, with generating embeddings of the first plurality of items and the second plurality of items based on the plurality of item attributes.

Operations 600 continue at step 608, with retrieving item selection data indicating whether items of the first plurality of items and the second plurality of items were historically selected by the plurality of users.

Operations 600 continue at step 610, with generating a labeled training data set for a machine learning model based on the user attributes, the embeddings, and the item selection data, wherein the training data set does not include identifiers of the first plurality of items and the second plurality of items.

Certain embodiments further comprise generating a unified data set by merging the user attributes and the item attributes based on the item selection data using the identifiers of the first plurality of items and the second plurality of items and user identifiers of the plurality of users and converting textual features in the unified data set into numerical features to produce a converted unified data set, wherein the labeled training data set is generated based on the converted unified data set.

Operations 600 continue at step 612, with training the machine learning model through a supervised learning process based on the labeled training data set to output indications of one or more recommended items of the first item type or the second item type in response to input user features, wherein the machine learning model is configured, as a result of the supervised learning process, to recognize latent relationships between the first plurality of items of the first item type and the second plurality of items of the second item type based on distances between the embeddings.

In some embodiments, the machine learning model is trained to process the input user features along with each embedding of the embeddings.

In certain embodiments, the indications comprise confidence scores for each of the first plurality of items and for each of the second plurality of items.

Some embodiments further comprise generating updated labeled training data based on user feedback with respect to an item selection recommendation output by the trained machine learning model, wherein the user feedback comprises a selection of one or more items within the software application, and re-training the machine learning model based on the user feedback, wherein the re-trained machine learning model is used to determine a subsequent item selection recommendation.

In certain embodiments, the first item type is tax deductions, the first plurality of items comprise a plurality of different tax deductions, the second item type is tax credits, and the second plurality of items comprise a plurality of different tax credits.

In some embodiments, the item features comprise names and categories.

In certain embodiments, the user attributes comprise one or more of: tax information for the plurality of users for a current year; and tax information for the plurality of users for a prior year.

In some embodiments, the machine learning model comprises a gradient boosted tree model.

### Example Computing Systems

FIG. 7A illustrates an example computing system 700 with which embodiments of the disclosure related to automatically recommending items for selection with a software application through machine learning may be implemented. For example, the computing system 700 may be representative of server 134 of FIG. 1.

The computing system 700 includes a central processing unit (CPU) 702, one or more I/O device interfaces 704 that may allow for the connection of various I/O devices 704 (e.g., keyboards, displays, mouse devices, pen input, etc.) to the computing system 700, a network interface 706, a memory 708, and an interconnect 712. It is contemplated that one or more components of the computing system 700 may be located remotely and accessed via a network 710. It is further contemplated that one or more components of the computing system 700 may include physical components or virtualized components.

The CPU 702 may retrieve and execute programming instructions stored in the memory 708. Similarly, the CPU 702 may retrieve and store application data residing in the memory 708. The interconnect 712 transmits programming instructions and application data, among the CPU 702, the I/O device interface 704, the network interface 706, the memory 708. The CPU 702 is included to be representative of a single CPU, multiple CPUs, a single CPU having multiple processing cores, and other arrangements.

Additionally, the memory 708 is included to be representative of a random access memory or the like. In some embodiments, the memory 708 may include a disk drive, solid state drive, or a collection of storage devices distributed across multiple storage systems. Although shown as a single unit, the memory 708 may be a combination of fixed and/or removable storage devices, such as fixed disc drives, removable memory cards or optical storage, network attached storage (NAS), or a storage area-network (SAN).

As shown, the memory 708 includes application 714, real-time recommendation component 718, machine learning model 719, cloud gateway 720, real-time feedback component 722, and data store 730, which may be representative of application 152, real-time recommendation component 156, machine learning model 136, cloud gateway 154, real-time feedback component 158, and data store 120 of FIG. 1. Data sets 732 in data store 730 may include, for example, user data set 122, item data set 124, item selection data set 126, and labeled training data set 130 of FIG. 1. Memory 708 further includes a model training engine 716, which may perform operations described herein for training machine learning model 719, such as corresponding to training pipeline 110 of FIG. 1.

FIG. 7B illustrates an example computing system 750 with which embodiments of the system related to automatically recommending items for selection with a software application through machine learning may be implemented. For example, the computing system 750 may be representative of user device 150 of FIG. 1.

The computing system 750 includes a central processing unit (CPU) 752, one or more I/O device interfaces 754 that may allow for the connection of various I/O devices 754 (e.g., keyboards, displays, mouse devices, pen input, etc.) to the computing system 750, a network interface 756, a memory 758, and an interconnect 760. It is contemplated that one or more components of the computing system 750 may be located remotely and accessed via a network 762. It is further contemplated that one or more components of the computing system 750 may include physical components or virtualized components.

The CPU 752 may retrieve and execute programming instructions stored in the memory 758. Similarly, the CPU 752 may retrieve and store application data residing in the memory 758. The interconnect 760 transmits programming instructions and application data, among the CPU 752, the I/O device interface 754, the network interface 756, the memory 758. The CPU 752 is included to be representative of a single CPU, multiple CPUs, a single CPU having multiple processing cores, and other arrangements.

Additionally, the memory 758 is included to be representative of a random access memory or the like. In some embodiments, the memory 758 may include a disk drive, solid state drive, or a collection of storage devices distributed across multiple storage systems. Although shown as a single unit, the memory 758 may be a combination of fixed and/or removable storage devices, such as fixed disc drives, removable memory cards or optical storage, network attached storage (NAS), or a storage area-network (SAN).

As shown, the memory 758 may include an application 764, such as application 152 discussed above with respect to FIG. 1.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored therecon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for automatically recommending items in a software application through machine learning, the method comprising:
retrieving a plurality of attributes of a user of the software application;
retrieving a machine learning model that has been trained through a supervised learning process based on labeled training data indicating whether a plurality of users represented by a plurality of user features historically selected, within the software application, first items of a first item type and second items of a second item type, wherein the machine learning model is configured, as a result of the supervised learning process, to recognize latent relationships between the first items of the first item type and the second items of the second item type based on distances between embeddings;
providing inputs to the machine learning model based on the plurality of attributes of the user;
receiving, from the machine learning model, in response to the inputs, indications of one or more recommended items of the first item type or the second item type; and
displaying, via a user interface, an item selection recommendation based on the indications of the one or more recommended items of the first item type or the second item type.

2. The method of claim 1, wherein the machine learning model processes the inputs along with each embedding of a plurality of embeddings generated based on the first items of the first item type and the second items of the second item type.

3. The method of claim 1, wherein the indications output by the machine learning model in response to the inputs comprise confidence scores for each of the first items of the first item type and for each of the second items of the second item type.

4. The method of claim 1, wherein the labeled training data set does not include identifiers of the first items of the first item type and the second items of the second type, and wherein the labeled training data set includes a respective embedding of each item of the first items of the first item type and the second items of the second type.

5. The method of claim 1, further comprising:
receiving, in response to the item selection recommendation, user feedback comprising a selection of one or more items within the software application, wherein the machine learning model is re-trained based on the user feedback; and
using the re-trained machine learning model to determine a subsequent item selection recommendation.

6. The method of claim 1, wherein the first item type is tax deductions, wherein the first items comprise a plurality of different tax deductions, wherein the second item type is tax credits, and wherein the second items comprise a plurality of different tax credits.

7. The method of claim 6, wherein the embeddings are generated based on features of the plurality of different tax deductions and the plurality of different tax credits, and wherein the features comprise names and categories.

8. The method of claim 6, wherein the plurality of attributes of the user comprise one or more of:
tax information for the user for a current year; and
tax information for the user for a prior year.

9. The method of claim 1, wherein the machine learning model comprises a gradient boosted tree model.

10. A method of machine learning model training, the method comprising:
retrieving user attributes of a plurality of users of a software application;
retrieving item attributes of a first plurality of items of a first item type and a second plurality of items of a second type;
generating embeddings of the first plurality of items and the second plurality of items based on the plurality of item attributes;
retrieving item selection data indicating whether items of the first plurality of items and the second plurality of items were historically selected by the plurality of users;
generating a labeled training data set for a machine learning model based on the user attributes, b, and the item selection data, wherein the training data set does not include identifiers of the first plurality of items and the second plurality of items; and
training the machine learning model through a supervised learning process based on the labeled training data set to output indications of one or more recommended items of the first item type or the second item type in response to input user features, wherein the machine learning model is configured, as a result of the supervised learning process, to recognize latent relationships between the first plurality of items of the first item type and the second plurality of items of the second item type based on distances between the embeddings.

11. The method of claim 10, wherein the machine learning model is trained to process the input user features along with each embedding of the embeddings.

12. The method of claim 11, wherein the indications comprise confidence scores for each of the first plurality of items and for each of the second plurality of items.

13. The method of claim 10, further comprising:
generating updated labeled training data based on user feedback with respect to an item selection recommendation output by the trained machine learning model, wherein the user feedback comprises a selection of one or more items within the software application; and
re-training the machine learning model based on the user feedback, wherein the re-trained machine learning model is used to determine a subsequent item selection recommendation.

14. The method of claim 10, wherein the first item type is tax deductions, wherein the first plurality of items comprise a plurality of different tax deductions, wherein the second item type is tax credits, and wherein the second plurality of items comprise a plurality of different tax credits.

15. The method of claim 10, wherein the item features comprise names and categories.

16. The method of claim 15, wherein the user attributes comprise one or more of:
tax information for the plurality of users for a current year; and
tax information for the plurality of users for a prior year.

17. The method of claim 10, wherein the machine learning model comprises a gradient boosted tree model.

18. The method of claim 10, further comprising:
generating a unified data set by merging the user attributes and the item attributes based on the item selection data using the identifiers of the first plurality of items and the second plurality of items and user identifiers of the plurality of users; and
converting textual features in the unified data set into numerical features to produce a converted unified data set, wherein the labeled training data set is generated based on the converted unified data set.

19. A system for automatically recommending items in a software application through machine learning, the system comprising:
one or more processors; and
one or more memory configured to store computer executable instructions that, when executed by the one or more processors, cause the one or more processors to:
retrieve a plurality of attributes of a user of the software application;
retrieve a machine learning model that has been trained through a supervised learning process based on labeled training data indicating whether a plurality of users represented by a plurality of user features historically selected, within the software application, first items of a first item type and second items of a second item type, wherein the machine learning model is configured, as a result of the supervised learning process, to recognize latent relationships between the first items of the first item type and the second items of the second item type based on distances between embeddings;
provide inputs to the machine learning model based on the plurality of attributes of the user;
receive, from the machine learning model, in response to the inputs, indications of one or more recommended items of the first item type or the second item type; and
display, via a user interface, an item selection recommendation based on the indications of the one or more recommended items of the first item type or the second item type.

20. The system of claim 19, wherein the machine learning model processes the inputs along with each embedding of a plurality of embeddings generated based on the first items of the first item type and the second items of the second item type.
